(19) United States
(12) Patent Application Publication
(10) Pub. No.: US 2014/0279132 A1
(43) Pub. Date: Sep. 18, 2014

(54) BUYER ASSIGNMENT FOR REQUISITIONS LINES

(71) Applicant: ORACLE INTERNATIONAL CORPORATION, Redwood Shores, CA (US)

(72) Inventors: Suman Guha, Fremont, CA (US); Michael Laurence Webb, Highlands Ranch, CO (US); Rohit Lobo Prabhu, Santa Clara, CA (US)

(73) Assignee: Oracle International Corporation, Redwood Shores, CA (US)

(21) Appl. No.: 13/800,301

(22) Filed: Mar. 13, 2013

(51) Int. Cl. G06Q 30/06

(52) U.S. Cl. CPC G06Q 30/0605
USPC 705/26.2

(57) ABSTRACT

A rules engine uses a set of sequenced rules in determining which rule to apply when assigning buyers in a procurement organization to requisitions submitted to the procurement organization. The rules are user-configurable to provide flexible reconfiguration of how the rules engine determines buyer assignments. Attributes of the requisitions may be utilized to determine the appropriate buyers by comparing the attributes with the rules. Sequencing of the rules allows for prioritization of the rules in instances where multiple rules may be applicable to a received requisition. Updates to a rule set can be tested on sample requisitions to allow users to see the results of the updates.

### BACKGROUND OF THE INVENTION

Organizations routinely purchase different items in various quantities to support their operations. An organization that manufactures goods, for instance, may purchase raw materials and other components used to produce the goods. Internal departments of an organization (e.g., accounting, human resources, legal, and the like) often require paper, pens, and other office supplies as well as computers and other devices. The larger and more complex an organization is, the more complicated its purchasing operations become. Many organizations, fir example, have departments whose purpose is to purchase items for their respective organizations. These departments may have multiple employees who, as part of their duties, manage procurement for the organization. Many procurement departments implement measures to optimize procurement for their respective organizations. A procurement department may, for example, have employees who focus on procurements for certain categories of items. In this manner, employees can become relative experts for their assigned categories, thereby allowing for improved purchasing decisions. Other employees may focus less on purchasing and more on obtaining agreements with suppliers so that other employees can use negotiated terms in their purchasing decisions. Because of the complexity of procurement in organizations, managing procurement can be a difficult endeavor.

### BRIEF SUMMARY OF THE INVENTION

Various embodiments of the present disclosure provide a user interface to author rules to assign buyers to requisition lines based on transaction attributes. Each rule consists of specified values for one or more of the following transaction attributes and a named buyer for assignment, when there is a match with the corresponding values on the requisition line. Example attributes include, but are not limited to: requisitioning business unit, commodity type, supplier, deliver-to organization, project, and procurement business unit. By virtue of being able to use more than one attribute value as part of the matching condition, procurement organizations are able to model far more complex dynamic allocation strategies than what the current hierarchy of setup objects can. For example, in some embodiments, a single rule can now be authored to designate a buyer specializing in all categories that fall under the Chemicals commodity that needs to be delivered to the Aircraft Engines facility (Deliver to Organization) in Cincinnati for the new 787E Engine prototyping project.

In some embodiments, each rule is given a unique sequence so that, when there are multiple matching rules that could be used to assign a buyer to the requisition line, the rule with the lowest sequence number is used for that assignment. Sequencing the rules facilitate easier maintenance of rules where rules with more specific criteria can be given a higher priority over rules with more coarse grained conditions. In this manner, it is not necessary to have a rule for every possible combination of values of the attributes mentioned above. For example, a detailed rule to assign a buyer A for procuring Solvents (a category under the commodity of Chemicals) in the Aircrafts Engines facility can be given a lower sequence number (and therefore higher priority) than a more generic rule to assign buyer B to procure Chemicals in the same facility. As a result, buyer A will handle procurement of Solvents in the facility and buyer B will handle procurement of all other Chemicals in that facility. An even more generic rule could be authored that will handle procurement of Chemicals in all facilities in the US Business unit. This will handle procurement of chemicals in facilities other than Aircraft Engines.

With the workload allocation strategy captured as a set of buyer assignment rules, embodiments of the present disclosure provide for a programmatic interface which evaluates new requisition lines as they get submitted, against the predefined set of buyer assignment rules, and narrows down to the rule with the highest priority and attributes that match the attributes on the requisition line. An application then assigns the requisition line to the buyer on this rule.

In an embodiment, the submitted requisition line has been assigned to the right buyer; this buyer can be included in the review and approval of the requisition line. User interfaces (UIs) to author approval routing rules may provide the ability to allow routing of requisition lines to the assigned buyer. This may be performed, for example, by including the assigned buyer as a possible “participant” in approval rules if the requisition line meets the rule conditions.

The ability to assign a buyer at the time of requisition submission and have the buyer review requisitions under certain conditions, in various embodiments, ensures that any issues with the requisition that will prevent efficient fulfillment can be addressed upfront before the requisition is even approved. After the requisition line is successfully approved, it can be processed into a purchase order, and managed by the same buyer until fulfillment.

Since workload allocation plans can be composed of several hundred buyer assignment rules, the solution allows for download and upload of rules to/from a spreadsheet application (e.g., Microsoft Excel®) to allow organizations to quickly create rules, and perform offline analysis and adjustments. This capability may also facilitate uptake of the solution by those organizations who may already be maintaining such rules in a spreadsheet. Workload allocation plans may also be affected by personnel changes in the procurement organization, such as attrition and re-assignment of personnel to other responsibilities. The capability to manipulate these assignment rules using a spreadsheet application allows for ease of ongoing maintenance of these assignment rules when affected by personnel changes. In some embodiments, management of such personnel change may be performed without export to a spreadsheet application.

In an embodiment, a workload allocation strategy may be complex and in such cases a procurement organization may desire the assurance that the workload allocation plan is accurate and predictable and that a workload allocation system is, in fact, assigning the right (e.g., intended) buyer to each requisition line. The solution provides for tools to test the predictability of buyer assignment based on the rules specified. Using these tools, in various embodiments, procurement organizations can run what-if scenarios to simulate new requisition lines being evaluated and check that in each scenario the right buyer is being assigned to the requisition line in question.

In some embodiments, a computer-implemented method for processing requests is performed under the control of one or more computer systems configured with executable instructions. The method, in an embodiment, includes: storing a rule set that comprises a plurality of rules, each rule of the plurality of rules having a sequence number, one or more conditions, and an outcome; receiving one or more attributes of a request; determining, based at least in part on the received one or more attributes, whether one or more of the plurality of rules have corresponding conditions satisfied by the received one or more attributes; as a result of determining that one or more of the plurality of rules have corresponding conditions satisfied by the received one or more attributes, selecting a rule of the plurality of rules based at least in part on a corresponding sequence number for the rule; and causing an outcome of the selected rule to be fulfilled.

Numerous variations of the method are considered as being within the scope of the present disclosure. For example, in some embodiments, the request is a requisition and, for each rule of the plurality of rules, the outcome identifies a buyer. Further, the method may include additional operations, such as: providing a user interface configured to enable management of the rule set; receiving, through the user interface, user input that defines one or more conditions and one or more outcomes for a new rule; and adding the new rule to the rule set. Other example additional operations include receiving one or more attributes for another request; selecting, from the plurality of rules, a set of rules whose conditions are satisfied by the one or more attributes of the other request; and providing for display information that identifies the selected rules. In some embodiments, the method includes determining, based at least in part on a sequence number and one or more conditions for a rule from the set of rules, whether the rule is unexecutable; and when determined that the rule is unexecutable, providing for display an indication of the rule being unexecutable. Also, the method may comprise generating a spreadsheet document that encodes the rule set; receiving the spreadsheet document after it has been edited to modify the rule set; and update the rule set based at least in part on the edited spreadsheet document.

In some embodiments, a computer system is provided. The computer system includes one or more processors; and memory including instructions editable by the one or more processors to cause the computer system to at least: store a rule set that comprises a plurality of rules, each rule of the plurality of rules having a sequence number, one or more conditions, and an outcome; receive one or more attributes of a request; determine, based at least in part on the received one or more attributes, whether one or more of the plurality of rules have corresponding conditions satisfied by the received one or more attributes; as a result of determining that one or more of the plurality of rules have corresponding conditions satisfied by the received one or more attributes, select a rule of the plurality of rules based at least in part on a corresponding sequence number for the rule; and cause an outcome of the selected rule to be fulfilled.

Numerous variations of the computer system are considered as being within the scope of the present disclosure. For example, the request may be a requisition. The instructions may further cause the computer system to: provide a user interface configured to enable management of the rule set; receive, through the user interface, user input that defines one or more conditions and one or more outcomes for a new rule; and add the new rule to the rule set. In some embodiments, the instructions further cause the computer system to: receive one or more attributes for another request; select, from the plurality of rules, a set of rules whose conditions are satisfied by the one or more attributes of the other request; and provide for display information that identifies the selected rules. Also, the instructions may further cause the computer system to: determine, based at least in part on a sequence number and one or more conditions for a rule from the set of rules, whether the rule is unexecutable; and when determined that the rule is unexecutable, provide for display an indication of the rule being unexecutable. In some embodiments, the instructions further cause the computer system to update the rule set based at least in part on a spreadsheet document that encodes a modified version of the rule set.

In some embodiments, a non-transitory computer-readable storage medium is provided, where the storage medium stores instructions that, when executed by one or more processors of a computer system, cause the computer system to perform operations, where the instructions include: instructions that, when executed, cause the computer system to store a rule set that comprises a plurality of rules, each rule of the plurality of rules having a sequence number, one or more conditions, and an outcome; instructions that, when executed, cause the computer system to receive one or more attributes of a request; instructions that, when executed, cause the computer system to determine, based at least in part on the received one or more attributes, whether one or more of the plurality of rules have corresponding conditions satisfied by the received one or more attributes; instructions that, when executed, cause the computer system to, as a result of determining that one or more of the plurality of rules have corresponding conditions satisfied by the received one or more attributes, select a rule of the plurality of rules based at least in part on a corresponding sequence number for the rule; and instructions that, when executed, cause the computer system to cause an outcome of the selected rule to be fulfilled.

Numerous variations of the computer-readable storage medium are considered as being within the scope of the present disclosure. For example, the outcome of each rule may be a buyer assignment. The instructions may further comprise instructions that cause the computer system to: provide a user interface configured to enable management of the rule set; receive, through the user interface, user input that defines one or more conditions and one or more outcomes for a new rule; and add the new rule to the rule set. The instructions may also further comprise instructions that cause the computer system to: receive one or more attributes for another request; select, from the plurality of rules, a set of rules whose conditions are satisfied by the one or more attributes of the other request; and provide for display information that identifies the selected rules. In some embodiments, the instructions further comprise instructions that cause the computer system to: identify rules that are unexecutable; and provide for display indications of the rules identified as unexecutable. Also, the instructions may further comprise instructions that cause the computer system to: import a document that encodes a change to the plurality of rules; and update the plurality of rules based at least in part on the document. The document may be a spreadsheet document. Receiving the one or more attributes of the request, in some embodiments, includes receiving a requisition that encodes the one or more attributes.

### BRIEF DESCRIPTION OF THE DRAWINGS

Various embodiments in accordance with the present disclosure will be described in reference to the drawings, in which:

FIG. 1 shows an illustrative example of an environment in which various embodiments of the present disclosure may be practiced;

FIG. 2 shows an illustrative example of a process for processing a requisition in accordance with at least one embodiment;

FIG. 3 shows an illustrative example of a user interface for managing rules used by a rules engine in accordance with at least one embodiment;

FIG. 4 shows an illustrative example of a user interface for testing rules used by a rules engine in accordance with at least one embodiment;

FIG. 5 shows an illustrative example of a process for assigning a requisition to a buyer in accordance with at least one embodiment;

FIG. 6 shows an illustrative example of a process for testing rules in accordance with at least one embodiment;

FIG. 7 shows an illustrative example of an environment in which various embodiments of the present disclosure may be practiced; and

FIG. 8 shows a simplified block diagram of a computer system that may be used to practice an embodiment of the present invention;

### DETAILED DESCRIPTION OF THE INVENTION

In the following description, for the purposes of explanation, specific details are set forth in order to provide a thorough understanding of embodiments of the invention. However, it will be apparent that the invention may be practiced without these specific details.

The following description describes an embodiment of the present invention in the procurement domain. However, the scope of the present invention is not restricted to procurement, but may be applied to other domains or applications. For example, any domain or application where rules engines are used in connection with fulfilling requests may make use of the present invention. Examples of domains in which embodiments of the present invention may be used include domains where request processing includes selection from a set of entities capable of fulfilling requests.

FIG. 1 shows an illustrative example of an environment 100 that may be used to implement various embodiments of the present disclosure. As illustrated, the environment 100 includes a purchasing system that includes a requisition routing engine 104. The purchasing system 102 may be implemented in a variety of ways. For example, in some embodiments, the purchasing system is a computer system (e.g., server computer system, either virtual or physical) configured to perform operations related to procurement, such as those described elsewhere herein and possibly additional operations. The purchasing system 102 may also be a programming module of a computer system that is configured with executable instructions that cause the computer system to perform various procurement-related operations. The requisition routing engine 104 may be a computer system (e.g., sub-system of the purchasing system 102) or programming module (e.g., sub-module of the purchasing system 102) that is configured to assign procurement tasks to buyers, such as described in more detail below.

As illustrated in FIG. 1, the purchasing system 102 receives requisitions from requestors. A requisition, in an embodiment, is a formalized request for an item or collection of items. A requisition may be an electronic document that encodes the attributes of the request. The attributes may be encoded in a structured manner so that the document is configured in a manner acceptable for processing by the purchasing system 102. A requisition may be provided to the purchasing system in various ways in accordance with various embodiments. For example, in an embodiment, the purchasing system 102 provides a web-based interface through which requestors may provide input for requisitions and submit the requisitions to the purchasing system 102. In other embodiments, a client-side application provides a user interface that allows for input for requisitions and transmission of the requisitions over a network to the purchasing system 102 in a format acceptable to the purchasing system 102. Input for a requisition may be provided in various ways. For instance, in some embodiments, items for purchasing are selectable from a catalog of items. The catalog (or multiple catalogs) may be generated based on a procurement department's negotiations with suppliers. In some instances, such as when an uncatalogued item is requested, input may be provided that enables a buyer to find a suitable supplier.

It should be noted that, while the requestors are illustrated in FIG. 1 as human operators, requestors may be computer systems operating according to automated processes. For example, requisitions may be automatically produced according to a schedule or detection of a need for one or more items. Further, while not illustrated in the figure, human operators may submit requisitions through corresponding devices operated by the human operators. Example devices include, but are not limited to, personal computers, notebook computers, mobile computing devices, tablet computing devices, and/or other devices.

As depicted in FIG. 1, the purchasing system 102 is configured to receive requisitions and assign corresponding purchasing responsibility to appropriate buyers. As one example, when the purchasing system 102 receives a requisition, the purchasing system 102 selects a buyer to be responsible for the requisition. It should be noted that responsibility for a requisition may not require any action on behalf of a buyer selected for the requisition. For example, many requisitions may be processed automatically, requiring no intervention on behalf of the selected buyer. The buyer may be selected for the purpose of being responsible in circumstances where automatic processing fails, such as in circumstances when a supplier could not be determined or an agreement could not be located for the item on the requisition. Assignment of a buyer may be performed in various ways. For example, the requisition and associated information (e.g., corresponding purchase order generated based at least in part on the requisition) may be associated with the selected buyer in a database and/or other actions may be taken. A queue of items to be handled by the buyer may be updated and/or one or more electronic or other notifications to the buyer of the requisition may be made.

FIG. 2 shows an illustrative example of a process 200 that may be used to implement various embodiments of the present disclosure. Some or all of the process 200 (or any other processes described herein, or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory. Referring to FIG. 1, the process 200 may be performed by the purchasing system 102 or, depending on the particular configuration being used, collectively by the purchasing system 102 and a device of a requestor.

In an embodiment, the process 200 includes creating 202 a requisition. Creating a requisition may be performed in any suitable manner, such as by receiving user input into a computing device. The user input may select or otherwise specify attributes for the requisition and the user input may be collected to form the requisition. Once created 204, the process 200 may include submitting 204 the created requisition. Submitting 204 the requisition may be performed in various ways in accordance with the various embodiments. Generally, submitting 204 the requisition may include one or more operations that result in the requisition being available for processing in a requisition processing workflow. As shown in FIG. 2, part of the requisition processing workflow may include determining and assigning 206 an optimal buyer, such as described above. As discussed in more detail below, a rules engine (such as a requisition routing engine 104 discussed above in connection with FIG. 1) may be used to determine the optimal buyer. It should be noted that, while certain buyers may be optimal according to various metrics, other buyers may be actually more optimal than the determined optimal buyer. For example, in some scenarios, multiple rules may be found to match the requisition line. Yet, the optimal buyer may be the one on the rule with the lowest sequence number. As another example, a buyer may be determined to be an optimal buyer by virtue of being a catchall buyer (a buyer that handles requisitions to which no rules otherwise dictate assignment to another specific buyer).

Once an optimal buyer has been determined and assigned 206, the process 200 may include routing 208 the requisition for approval. As with other operations described herein, routing 208 the requisition for approval may be performed in various ways. For example, the requisition may be assigned to a queue that is reviewed by the assigned buyer. The assigned buyer may be able to access a user interface that displays the queue and allows the buyer to approve or deny the requisition. As another example, the assigned buyer may be provided an electronic message (e.g., email message) that includes a user interface allowing the assigned buyer to approve or deny the requisition or possibly a list of multiple requisitions assigned to the buyer). Regardless of how routed 208, the process 200 may include the buyer reviewing and approving 210 the requisition, such as described above. It should be noted that, while the reviewing and approving of the requisition may be performed according to user input provided by the buyer, the requisition may be reviewed and/or approved in an automated manner. For example, requisitions satisfying certain criteria (e.g., for amounts less than a threshold and/or for certain items) may be reviewed and/or approved by an automated system programmed to check the criteria and approve the requisition on behalf of the buyer.

Once reviewed and approved 210, the process 200 may include automatically processing the requisition to convert 212 the requisition to a purchase order or, generally, to an order. A purchase order may be a document, electronic or otherwise, that encodes an offer to purchase one or more items specified by the requisition. The purchase order may specify a price or have an implied price (e.g., pursuant to a previously made agreement or to a current catalog or market price). The purchase order may be configured according to a supplier system that processes orders and may include attributes that are the same as or otherwise based at least in part on attributes of the requisition. Accordingly, once the order has been created, the process 200 may include submitting 214 the purchase order, which may be performed in various ways according to the various embodiments. For example, submitting the purchase order may include transmitting the purchase order to a supplier electronically or by generating a paper document that is mailed, faxed, or otherwise transmitted to the supplier.

As discussed, embodiments of the present disclosure allow for flexibility, configurability, and extensibility for procurement systems. In some embodiments, users of a purchasing system (also referred to herein as a procurement system) are able to quickly and easily define rules for assignments of requisitions to buyers. A rule, as used herein, may comprise a set of conditions and an outcome for when the conditions are satisfied. A rule may be used by a rules engine for selecting a buyer for a requisition, such as described in more detail below, FIG. 3 shows an illustrative example of a portion of a graphical user interface that allows for definition and reconfiguration of rules for requisition assignment to buyers.

As illustrated in FIG. 3, the example graphical user interface is in the form of a table 300 having rows and columns. Each row corresponds to a rule. Columns in the table correspond to either an attribute defining a condition for the rule or an attribute for an outcome (e.g., specified buyer). For example, a first column labeled in this example as “Rule Seq.” corresponds to sequence numbers for rules defined in the table. A value in the Rule Seq. column, where the column intersects a row for a rule, indicates the rule's place in a sequence of rules defined by the table. In this example, the rows are sequentially ordered in ascending sequence number, although variations of this presentation are considered as being within the scope of the present disclosure. Also, as illustrated in this example, sequence numbers are allowed to take on non-integer values. In this manner, if a user wants to, for example, insert a new rule between a rule with sequence number 2 and a rule with sequence number 3, the user can give the new rule a sequence number that is between 2 and 3, such as 2.5. Upon further updating the rules, the user (or another user) can insert a rule between the rule with sequence number 2.5 and the sequence number 3 by creating a rule with a sequence number between 2.5 and 3, such as 2.9.

In an embodiment, the various values in the table 300 are editable for the purpose of changing rules. For example, a new sequence number can be given to a rule by selecting the corresponding value in the Rule Seq. column and typing or otherwise inputting a new value. The user interface, upon updating a sequence number, may reorder the presentation of rules accordingly. As illustrated, various conditions for the rule are also editable. For example, conditions defined by the entries in the column labeled as “Cond. 1” may be edited by changing corresponding values. In this example, various user interface tools facilitate user input. For example, entries in the Cond. 1 column are editable by selecting an arrow of a drop-down box. A user may select (e.g., click on) the arrow to cause a list of selectable attributes to appear. For some conditions, e.g. conditions defined in the column labeled “Cond. 3,” a search user interface element is provided. A search user interface element may be selected to cause a pop-up user interface to appear, where the pop-up user interface enables entry of search criteria to execute a search for selectable values to define the condition. A search user interface element may be provided, for example, where the number of possible selectable values are too numerous to practically include in a drop-down menu. For example, a search user interface element may allow for searching a directory structure. For some conditions, such as for conditions defined by entries in the column labeled as “Cond. N,” users may be able to directly enter (e.g., by typing or otherwise inputting) values to define the condition. Accordingly, entries in the Cond. N column are editable by selecting and typing values into a text box. Such text boxes may be useful, for example, where search user interface elements and drop-down boxes are impractical. As one example, the Cond. N column may have entries that define conditions for requisition dollar amounts.

Numerous types of conditions may be definable using the table 300. Example conditions include, but are not limited to, requisitioning business unit (BU), commodity type, deliver-to organization, project identifier, supplier, non-catalogue request (which may be a Boolean value selectable for requests for items not appearing in a catalogue of available items), a requisition line amount, and a currency type (e.g., USD or EUR). While not shown, the table 300 may include rule attributes, such as attributes that define which rule set a rule belongs to (if multiple rule sets are used). While not illustrated as such, conditions for rules may have selectable attributes that depend on attributes selected from another condition. For example, if a particular requisitioning business unit is selected, the attributes selectable for one or more other conditions may be updated so as to apply to the selected business unit. Further, a rule may be defined by selecting or otherwise specifying values in one or more columns for a corresponding row, but not all columns need be used.

In an embodiment, for a rule, each specified value for the rule defines a condition that must be satisfied for the rule to apply. It should be noted, however, that more complex conditions may be definable in various embodiments. For example, in some embodiments, Boolean attributes may be selectable to allow for, as an example, definition of a rule that is applicable if one of several conditions are satisfied. Other variations are also considered as being within the scope of the present disclosure.

To create a new rule, in an embodiment, a user may provide input into a blank row of the table 300 (not shown) or otherwise provide input that can be used to populate entries of a row of the table 300. As noted above, the user can give the rule a sequence number that causes the rule to be processed in the sequence of rules of the user's choice. Upon entry of a new rule into the table 300, a rules engine that uses rules defined by the table 300 may be updated to operate according to the updated rule set.

As illustrated in FIG. 3, the table 300 includes one or more columns that allow specification of outcomes for rules. In this example, two columns are provided, although other configurations are considered as being within the scope of the present disclosure. In this example, the columns are functionally related. For example a column labeled “Procurement BU” allows a procurement business unit to be specified for the rule. Selectable procurement businesses units may be useful, for example, where an organization has multiple procurement business that are used for procurement, such as when the organization is large enough that multiple procurement businesses units are practical for efficient procurement. As illustrated, the Procurement BU column may include a drop-down menu that allows selection from a plurality of selectable business units of an organization. A column labeled “Buyer” allows specification of a buyer from the selected procurement business unit or, if a procurement business unit is not selected, from among all available buyers in an organization.

In this manner, when a requisition is received, if the requisition satisfies the conditions specified by the rule, the requisition may be assigned to the buyer specified in the rule. As discussed in more detail below, whether an applicable rule applies may depend at least in part on the rule's sequence number and, in particular, whether any other rules with a lower sequence number also apply.

In various embodiments, rules and rule sets are testable before being put to use and/or at other times. FIG. 4, accordingly, shows an illustrative example of a user interface 400 that may be used to test rules. The user interface 400 may be part of an application used to implement a purchasing system, such as described above. The user interface 400 may be, for example, part of an application executing on a computing device implementing a purchasing system or, in some examples, the user interface 400 may be provided as a web-based interface that is remotely accessible through a web server operating in connection with a purchasing system. Regardless of how implemented, an application providing the user interface 400 may be configured to receive and process or provide for processing input that is entered into the user interface 400.

In this example, the user interface 400 is apportioned among a requisition attribute input section 402 and a results section 404, although other configurations are considered as being within the scope of the present disclosure. The requisition attribute input section 402, in an embodiment, includes user interface controls (e.g., text boxes, drop-down menus, etc.) that allow a user to provide one or more attributes of a potential requisition. A user may use the user interface controls to specify attributes for a sample requisition to check whether the sample requisition is assigned to the buyer the user intends. Once attributes for a requisition have been provided, the user may execute a search to locate rules that apply to the sample requisition. For example, as illustrated in FIG. 4, a user may select a “Search” button 406 user interface control to cause a search of applicable rules to be performed. Selection of the Search button may cause, for example, an analysis of each rule to determine which rules, if any, the requisition satisfies. A system may, for instance, sequentially determine whether the requisition satisfies any conditions for each rule and identify which rules' conditions are satisfied. A “Reset” button 408 may be used to reset sample requisition attributes to default values.

As illustrated in FIG. 4, the results section 40.4 may be populated with rules having conditions that are satisfied by the sample requisition. The rules appearing in the results section may include user interface controls, such as described above, to enable a user to update, add, or subtract attributes for a rule or otherwise change a rule. A user may, for instance, update a sequence number so that one rule is applied before another. Conditions for a rule and/or outcomes for the rule may also be updated, in an embodiment, in the results section.

Various enhancements may also be performed by a system in connection with which the user interface 400 is provided. For example, upon performance of a search for rules whose criteria are satisfied by a sample requisition, the search results (rules whose conditions are satisfied) may be analyzed to provide additional information to the user. For example, as illustrated in FIG. 4, analysis of matching rules has resulted in a warning icon 410 to appear. The warning icon indicates some issue identified by the analysis. In this example, a pop-up box 412 appears providing information about the identified issue. In this particular illustrative example, a rule for which the warning icon 410 appeared will never be applied since, although the rule's conditions are met, another rule with a lower sequence number will always apply to a requisition to which the rule with the warning icon 410 applies. In other words, the conditions of the rule with the warning icon 410 are defined such that another rule would always be applied first. In this manner, the user is able to view the information and, if desired, take corrective action, such as by resequencing one or more rules, modifying the conditions of one or more rules, and/or deleting one or more rules. Upon updating the rule set, analysis may again be performed to provide feedback to the user regarding the changes that were made (e.g., whether any identified issues have been resolved).

As noted above, in various embodiments, multiple rules may be applicable to a particular requisition, but only one rule may be applied based at least in part on applicable rules' sequence numbers. FIG. 5 shows an illustrative example of a process 500 for evaluating a requisition in accordance with an embodiment. The process 500 may be performed by any suitable system, such as by a requisition routing engine, such as described above in connection with FIG. 1. Returning to FIG. 5, in an embodiment, the process 500 includes receiving 502 attributes for a requisition. Receiving 502 the attributes for the requisition may be performed in any suitable manner. For example, in some embodiments, the attributes may be extracted from a requisition that was submitted to a system performing the process 500. Once the attributes for the requisition are received 502, the process 500 may include accessing 504 (e.g., obtaining from memory or otherwise obtaining for processing) the first rule from a sequence of rules. It should be noted that the complete rule need not be accessed at this point, but only the portion of the rule that encodes any conditions that are required to be met by the rule.

A determination may be made 506 whether the requisition attributes satisfy conditions of the accessed rule required to be satisfied for the rule to apply. Determining 506 whether the requisition attributes satisfy the conditions of the accessed rule may be performed in any suitable manner, such as by sequentially analyzing each condition of the accessed rule until either a condition is not met or all conditions of the rule are met. In an embodiment, if determined 506 that the requisition does not satisfy′ conditions of the accessed rule, the process 500 may include determining 508 whether there are any additional rules to analyze. If determined 508 that there are additional rules to analyze, the process 500 may include accessing 504 the next rule and determining 506 whether conditions of the next rule are satisfied.

This sub-process may repeat, as illustrated in FIG. 5, until a determination is made 508 that there are no additional rules or a determination is made 506 that the requisition attributes satisfy the conditions of the accessed rule currently being analyzed. In the case that a determination is made 508 that there are no additional rules to analyze (e.g., the last rule in a sequence has been analyzed), the process 500 may include assigning 510 a catchall buyer, which may be a buyer having a role of managing requisitions to which no rule applies. There may be a single catchall buyer or the catchall buyer may be selected from multiple catchall buyers. Other variations are also considered as being within the scope of the present disclosure. For example, if no rule applies, the requisition can be randomly or otherwise (e.g., in round robin style, based at least in part on buyer queue size, or in accordance with any other load balancing techniques) assigned to any of the buyers or any of a subset of the buyers to which requisitions may be assigned.

in the case that a determination is made 506 that the requisition satisfies one or more conditions of a rule (which, in the illustrated embodiment, would be the first rule in the sequence for which this was the case), the process 500 may include assigning 512 the requisition to the buyer specified by the rule whose conditions are satisfied by the requisition attributes. In this manner, the first rule in the sequence whose condition(s) are satisfied is the rule used to assign the buyer. Additionally, in some cases, the process 500 may also include accessing multiple rules (e.g., all available and/or accessible rules) 504 at the same time and/or in parallel. In this way, each rule may be accessed and evaluated together, and a set of satisfactory rule conditions may be determined together 506 (i.e., rules that match attributes may be determined). In this example, buyers may then be assigned 512 based at least in part on appropriate sequence numbers (e.g., buyers may be assigned to matched rules with the lowest sequence number) of the requisitions determined to satisfy (i.e., match) the rules that were evaluated.

As noted above, embodiments of the present disclosure provide users the ability to test rules that they have created or modified to see how rules would be applied to requisitions having particular attributes. FIG. 6, accordingly, shows an illustrative example of a process 600 for testing rules in accordance with an embodiment. The process 600 may be performed by any suitable system, such as a purchasing system described above in connection with FIG. 1 and/or a rules engine such as described above in connection with FIG. 1. As illustrated, the process 600 includes receiving 602 test requisition attributes. Test requisition attributes may be received in any suitable manner, such as through a user interface (web or otherwise), an example of which is described in connection with FIG. 4. Receiving the test requisition attributes may also include receiving an actual (e.g., sample or real) requisition. Generally, the test requisition attributes may be attributes for a requisition that is being used to test how a rules engine or other system assigns a buyer for the requisition.

Once the test requisition attributes are received 602, the process 600 includes identifying 604 any rules that match the test requisition attributes (i.e., rules whose conditions are met by a requisition having the test requisition attributes). Identifying any rules that match the test requisition attributes may be performed in various ways in accordance with the various embodiments. For example, rules may be checked (e.g., each and/or all rules may be queried and/or analyzed in a single pass or other parallel fashion), such as described above in connection with FIG. 5. Instead of stopping when a rule whose conditions are met, the process 600 may include analyzing all rules in a rule set and marking in memory those rules whose conditions are met by the test requisition attributes. While not illustrated, the process 600 may include appropriate operations in instances when no rules match the test requisition attributes. For example, a message indicating such may be presented to the user.

Once any rules matching the test requisition attributes are identified 604, the process 600 may include identifying 606 any non-executable rules. A non-executable rule may be a rule that, because of its conditions and because of its position in a sequence of rules, would result in programming logic of a rule engine (such as described above in connection with FIG. 1) that would never get applied to a requisition for the purpose of assigning a buyer. As one example, a catalogue of items may be hierarchically arranged. If a rule at a sequence position was applicable to all office supplies, another rule with a lower sequence position (and hence higher rule sequence number) for copier paper (a sub-category of office supplies) would never get applied because the rule applicable to all office supplies would be found to be applicable first. Accordingly, the process 600 may include analyzing each rule of the identified 604 rules to determine whether, for the rule's set of conditions, any rules with lower sequence numbers have: (1) their set of conditions being a subset (not necessarily a proper subset) of the rule's conditions; and (2) each condition of their set of conditions being the same as or less restrictive than the corresponding condition of the rule.

In an embodiment, once the non-executable rules are identified, the process 600 may include providing 608 for display information identifying the non-executable rules that match the test requisition attributes. For example, referring to FIG. 4, the process 400 may include updating a user interface to include visual indicators of which rules are non-executable and/or providing information about the reason for being non-executable. In some embodiments, visual information about a reason for being non-executable is provided separately, such as when a visual indicator is selected (e.g., by a hover-over or click).

FIG. 7 is a simplified block diagram illustrating components of a system environment 700 that may be used in accordance with an embodiment of the present disclosure. As shown, system environment 700 includes one or more client computing devices 702, 704, 706, 708, which are configured to operate a client application such as a web browser, proprietary client (e.g., Oracle Forms), or the like over one or more networks 710 (such as, but not limited t), networks similar to the networks 108 of FIGS. 1 and 3). In various embodiments, client computing devices 702, 704, 706, and 708 may interact with a server 712 over the networks 710.

Client computing devices 702, 704, 706, 708 may be general purpose personal computers (including, by way of example, personal computers and/or laptop computers running various versions of Microsoft Windows and/or Apple Macintosh operating systems), cell phones or PDAs (running software such as Microsoft Windows Mobile and being Internet, e-mail, SMS, Blackberry, or other communication protocol enabled), and/or workstation computers running any of a variety of commercially-available UNIX or UNIX-like operating systems (including without limitation the variety of GNU/Linux operating systems). Alternatively, client computing devices 702, 704, 706, and 708 may be any other electronic device, such as a thin-client computer, Internet-enabled gaming system, and/or personal messaging device, capable of communicating over a network (e.g., network 710 described below). Although exemplary system environment 700 is shown with four client computing devices, any number of client computing devices may be supported. Other, devices such as devices with sensors, etc, may interact with server 712.

System environment 700 may include networks 710. Networks 710 may be any type of network familiar to those skilled in the art that can support data communications using any of a variety of commercially-available protocols, including without limitation TCP/IP, SNA, IPX, AppleTalk, and the like. Merely by way of example, network 710 can be a local area network (LAN), such as an Ethernet network, a Token-Ring network and/or the like; a wide-area network; a virtual network, including without limitation a virtual private network (VPN); the Internet; an intranet; extranet; a public switched telephone network (PSTN); an infra-red network; a wireless network (e.g., a network operating under any of the IEEE 802.11 suite of protocols, the Bluetooth protocol known in the art, and/or any other wireless protocol); and/or any combination of these and/or other networks.

System environment 700 also includes one or more server computers 712 which may be general purpose computers, specialized server computers (including, by way of example, PC servers, UNIX servers, mid-range servers, mainframe computers, rack-mounted servers, etc.), server farms, server clusters, or any other appropriate arrangement and/or combination. In various embodiments, server 712 may be adapted to run one or more services or software applications described in the foregoing disclosure. For example, server 712 may correspond to a server for performing processing described above according to an embodiment of the present disclosure.

Server 712 may run an operating system including any of those discussed above, as well as any commercially available server operating system. Server 712 may also run any of a variety of additional server applications and/or mid-tier applications, including HTTP servers, FTP servers, CGI servers, Java servers, database servers, and the like. Exemplary database servers include without limitation those commercially available from Oracle, Microsoft, Sybase, IBM and the like.

System environment 700 may also include one or more databases 714, 716. Databases 714, 716 may reside in a variety of locations. By way of example, one or more of databases 714, 716 may reside on a non-transitory storage medium local to (and/or resident in) server 712. Alternatively, databases 714, 716 may be remote from server 712, and in communication with server 712 via a network-based or dedicated connection. In one set of embodiments, databases 714, 716 may reside in a storage-area network (SAN) familiar to those skilled in the art. Similarly, any necessary files for performing the functions attributed to server 712 may be stored locally on server 712 and/or remotely, as appropriate. In one set of embodiments, databases 714, 716 may include relational databases, such as databases provided by Oracle, that are adapted to store, update, and retrieve data in response to SQL-formatted commands.

FIG. 8 is a simplified block diagram of a computer system 800 that may be used in accordance with embodiments of the present disclosure. For example service provider computers 106 may be implemented using a system such as system 800. Computer system 800 is shown comprising hardware elements that may be electrically and/or communicatively coupled via a bus 801. The hardware elements may include one or more central processing units (CPUs) 802, one or more input devices 804 (e.g., a mouse, a keyboard, etc.), and one or more output devices 806 (e.g., a display device, a printer, etc.). Computer system 800 may also include one or more storage devices 808. By way of example, the storage device(s) 808 may include devices such as disk drives, optical storage devices, and solid-state storage devices such as a random access memory (RAM) and/or a read-only memory (ROM), which can be programmable, flash-updateable and/or the like.

Computer system 800 may additionally include a computer-readable storage media reader 812, a communications subsystem 814 (e.g., a modem, a network card (wireless or wired), an infra-red communication device, etc.), and working memory 818, which may include RAM and ROM devices as described above. In some embodiments, computer system 800 may also include a processing acceleration unit 816, which can include a digital signal processor (DSP), a special-purpose processor, and/or the like.

Computer-readable storage media reader 812 can further be connected to a computer-readable storage medium 810, together (and, optionally, in combination with storage device(s) 808) comprehensively representing remote, local, fixed, and/or removable storage devices plus storage media for temporarily and/or more permanently containing computer-readable information. Communications system 814 may permit data to be exchanged with network 812 and/or any other computer described above with respect to system environment 800.

Computer system 800 may also comprise software elements, shown as being currently located within working memory 818, including an operating system 820 and/or other code 822, such as an application program (which may be a client application, Web browser, mid-tier application, RDBMS, etc.). In an exemplary embodiment, working memory 818 may include executable code and associated data structures used for relying party and open authorization-related processing as described above. It should be appreciated that alternative embodiments of computer system 800 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to, volatile and non-volatile (non-transitory), removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by a computer.

The techniques described and suggested herein provide numerous advantages over conventional techniques for buyer assignment. For example, various embodiments of the present disclosure provide increased flexibility. As described above, workload allocation strategies vary significantly from organization to organization and the challenge for any procurement system is to be able to accommodate these variations. The techniques described herein (and variations thereof) are simple and provides each organization the flexibility to create assignment rules that mirror their unique workload allocation strategies.

Further, various embodiments of the present disclosure provide organizations rapid response to change. For instance, procurement organizations can react to changes in their workload allocation strategies much more rapidly by simply modifying the rules to reflect the new policies. The ability to download and upload rules and maintain rules in a spreadsheets, for example, makes it even more easy for organizations to respond to changes quickly. In addition, various embodiments of the present disclosure provide increased procurement process efficiency. Procurement organizations, for instance, can prevent costly rework and delays by being able to assign the buyer with the right expertise to the requisition line, the first time. The procurement process is more efficient when there are no re-assignments of the requisition line from one buyer to another.

Using techniques described herein, a procurement organization can set up their desired workload allocation plan and get the right buyer assigned to each requisition line the first time. Furthermore, the right buyer when assigned to the requisition line can be included in the approval of the requisition so that any issues can be identified upfront and fixed, preventing a return of the requisition to the preparer, which is costly and delays the fulfillment process. In addition, the buyer with the right expertise is better able to handle the downstream purchase order, preventing further delays in its fulfillment.

Although specific embodiments of the disclosure have been described, various modifications, alterations, alternative constructions, and equivalents are also encompassed within the scope of the disclosure. Embodiments of the present disclosure are not restricted to operation within certain specific data processing environments, but are free to operate within a plurality of data processing environments. Additionally, although embodiments of the present disclosure have been described using a particular series of transactions and steps, it should be apparent to those skilled in the art that the scope of the present disclosure is not limited to the described series of transactions and steps.

Further, while embodiments of the present disclosure have been described using a particular combination of hardware and software, it should be recognized that other combinations of hardware and software are also within the scope of the present disclosure. Embodiments of the present disclosure may be implemented only in hardware, or only in software, or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope. Illustrative methods and systems for providing features of the present disclosure are described above. Some or all of these systems and methods may, but need not, be implemented at least partially by architectures such as those shown in FIGS. 1-8 above.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

1. A computer-implemented method, comprising:
under control of one or more computer systems configured with executable instructions,
storing a rule set that comprises a plurality of rules for assigning a buyer to a requisition line that includes a plurality of items capable of being purchased, each rule of the plurality of rules having a sequence number, one or more conditions, and an outcome;
receiving one or more transaction attributes of a request for an item of the plurality of items;
determining, based at least in part on the received one or more transaction attributes, whether one or more of the plurality of rules have corresponding conditions satisfied by the received one or more transaction attributes;
as a result of determining that one or more of the plurality of rules have corresponding conditions satisfied by the received one or more transaction attributes, selecting a rule of the plurality of rules based at least in part on a corresponding sequence number for the rule; and
identifying the buyer for at least one rule of the plurality of rules based at least in part on the selected rule.

2. (canceled)

3. The computer-implemented method of claim 1, further comprising:
providing a user interface configured to enable management of the rule set;
receiving, through the user interface, user input that defines one or more conditions and one or more outcomes for a new rule; and
adding the new rule to the rule set.

4. The computer-implemented method of claim 1, further comprising:
receiving one or more additional transaction attributes for another request;
selecting, from the plurality of rules, a set of rules whose conditions are satisfied by the one or more additional transaction attributes of the other request; and
providing for display information that identifies the selected rules.

5. The computer-implemented method of claim 4, further comprising:
determining, based at least in part on a sequence number and one or more conditions for a rule from the set of rules, whether the rule is unexecutable; and
when determined that the rule is unexecutable, providing for display an indication of the rule being unexecutable.

6. The computer-implemented method of claim 1, further comprising:
generating a spreadsheet document that encodes the rule set;
receiving the spreadsheet document after it has been edited to modify the rule set; and
update the rule set based at least in part on the edited spreadsheet document.

7. A computer system, comprising:
one or more processors; and
memory including instructions editable by the one or more processors to cause the computer system to at least:
store a rule set that comprises a plurality of rules, each rule of the plurality of rules having a sequence number, one or more conditions, and an outcome;
receive one or more attributes of a request;
determine, based at least in part on the received one or more attributes, whether one or more of the plurality of rules have corresponding conditions satisfied by the received one or more attributes;
as a result of determining that one or more of the plurality of rules have corresponding conditions satisfied by the received one or more attributes, select a rule of the plurality of rules based at least in part on a corresponding sequence number for the rule; and
cause an outcome of the selected rule to be fulfilled.

8. The computer-implemented method of claim 7, wherein the request is a requisition.

9. The computer-implemented method of claim 7, wherein the instructions further cause the computer system to:
provide a user interface configured to enable management of the rule set;
receive, through the user interface, user input that defines one or more conditions and one or more outcomes for a new rule; and
add the new rule to the rule set.

10. The computer-implemented method of claim 7, wherein the instructions further cause the computer system to:
receive one or more attributes for another request;
select, from the plurality of rules, a set of rules whose conditions are satisfied by the one or more attributes of the other request; and
provide for display information that identifies the selected rules.

11. The computer-implemented method of claim 10, wherein the instructions further cause the computer system to:
determine, based at least in part on a sequence number and one or more conditions for a rule from the set of rules, whether the rule is unexecutable; and
when determined that the rule is unexecutable, provide for display an indication of the rule being unexecutable.

12. The computer-implemented method of claim 7, wherein the instructions further cause the computer system to update the rule set based at least in part on a spreadsheet document that encodes a modified version of the rule set.

13. A non-transitory computer-readable storage medium having stored thereon instructions that, when executed by one or more processors of a computer system, cause the computer system to perform operations, the instructions including:
instructions that, when executed, cause the computer system to store a rule set that comprises a plurality of rules, each rule of the plurality of rules having a sequence number, one or more conditions, and an outcome;
instructions that, when executed, cause the computer system to receive one or more attributes of a request;
instructions that, when executed, cause the computer system to determine, based at least in part on the received one or more attributes, whether one or more of the plurality of rules have corresponding conditions satisfied by the received one or more attributes;
instructions that, when executed, cause the computer system to, as a result of determining that one or more of the plurality of rules have corresponding conditions satisfied by the received one or more attributes, select a rule of the plurality of rules based at least in part on a corresponding sequence number for the rule; and
instructions that, when executed, cause the computer system to cause an outcome of the selected rule to be fulfilled.

14. The computer-implemented method of claim 13, wherein the outcome is a buyer assignment.

15. The computer-implemented method of claim 13, wherein the instructions further comprise instructions that cause the computer system to:
provide a user interface configured to enable management of the rule set;
receive, through the user interface, user input that defines one or more conditions and one or more outcomes for a new rule; and
add the new rule to the rule set.

16. The computer-implemented method of claim 13, wherein the instructions further comprise instructions that cause the computer system to:
receive one or more attributes for another request;
select, from the plurality of rules, a set of rules whose conditions are satisfied by the one or more attributes of the other request; and
provide for display information that identifies the selected rules.

17. The computer-implemented method of claim 13, wherein the instructions further comprise instructions that cause the computer system to:
identify rules that are unexecutable; and
provide for display indications of the rules identified as unexecutable.

18. The computer-implemented method of claim 13, wherein the instructions further comprise instructions that cause the computer system to:
import a document that encodes a change to the plurality of rules; and
update the plurality of rules based at least in part on the document.

19. The computer-implemented method of claim 18, wherein the document is a spreadsheet document.

20. The computer-implemented method of claim 18, wherein receiving the one or more attributes of the request includes receiving a requisition that encodes the one or more attributes.
